(19) United States
(12) Patent Application Publication
(10) Pub. No.: US 2024/0176077 A1
(43) Pub. Date: May 30, 2024

(54) OPTICAL FIBER STRUCTURE AND OPTICAL FIBER ARRAY STRUCTURE

(71) Applicant: SHUNYUN TECHNOLOGY (ZHONG SHAN) LIMITED, Zhongshan (CN)

(72) Inventor: LI-KUN HUANG, Shenzhen (CN)

(21) Appl. No.: 18/095,949

(22) Filed: Jan. 11, 2023

(30) Foreign Application Priority Data
Nov. 25, 2022 (CN) 202211496561.6

(51) Int. Cl. G02B 6/36

(52) U.S. Cl. CPC G02B 6/3696; G02B 6/3636; G02B 6/3688

(57) ABSTRACT

An optical fiber structure, includes a substrate, provided with a holding slot; an optical fiber cable, partially arranged in the holding slot; and an isolator, comprising a positioning structure arranged in the holding slot and aligned with an end surface of the optical fiber cable. The present disclosure can not only improve the optical coupling accuracy but also make the optical fiber structure more compact by pasting the isolator in the holding slot and directly aligning with the end surface of the optical fiber cable, which provides a basis for the product to be miniaturized and integrated. The isolator includes a positioning structure, and the isolator has a unidirectional transmission characteristic, therefore, the positioning structure greatly reduces the assembly difficulty and improves the assembly efficiency.

### FIELD

The subject matter herein generally relates to a technical field of optical communication, in particular to an optical fiber structure and an optical fiber array structure.

### BACKGROUND

With the rapid development of communication technology and the rapid growth of practical applications, the research of large capacity optical fiber communication system has great application value. Optical fiber arrays are widely used in optical splitters and other products. They are assembled together with substrates to become important coupling components connecting optical emitting devices and optical receiving devices. Generally, the optical fiber arrays used in active optical modules have higher requirements, in order to achieve higher isolation, the isolator is directly bonded to a fiber core of an end surface of the optical fiber array. Due to the lack of positioning structure and small size of the isolator itself, and the need to ensure the position accuracy during mounting, the mounting process of the isolator is greatly difficult, and the accuracy during mounting cannot be guaranteed, resulting in the low coupling accuracy between the optical fiber array and the optical isolator.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is an application diagram of an optical fiber array according to an embodiment of the present disclosure.

FIG. 2 is an outside view of the optical fiber structure according to an embodiment of the present disclosure.

FIG. 3 is an outside view of a substrate according to an embodiment of the present disclosure.

FIG. 4 is an outside view of an isolator according to an embodiment of the present disclosure.

FIG. 5 is a side view of the isolator according to an embodiment of the present disclosure.

FIG. 6 is an outside view of the substrate according to another embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one”. The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

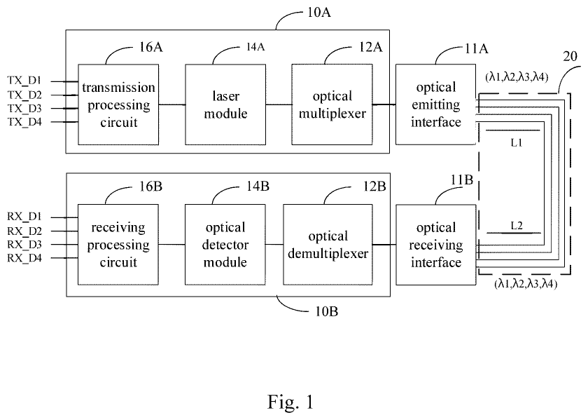

FIG. 1 is an application diagram of an optical fiber array according to an embodiment of the present disclosure. In the embodiment, an optical fiber array structure 20 is an important coupling component connecting the optical emitting device and the optical receiving device. The optical emitting device includes an optical emitting interface 11A and a transmitter optical subassembly 10A. The transmitter optical subassembly 10A includes a transmission processing circuit 16A, a laser module 14A, and an optical multiplexer 12A. The optical emitting device is connected to the optical fiber array structure 20 through the optical emitting interface 11A. The optical receiving device includes an optical receiving interface 11B and a receiver optical subassembly 10B. The receiver optical subassembly 10B includes an optical demultiplexer 12B, an optical detector module 14B, and a receiving processing circuit 16B. The optical receiving device is connected to an optical fiber cable through the optical receiving interface 11B. In the embodiment, the optical transmitting interface 11A and optical receiving interface 11B can be ST type, SC type, FC type, LC type, etc.

The dense wavelength division multiplexing (DWDM) technology has characteristics of bandwidth and low loss of single-mode fiber, which uses multiple wavelengths as carriers, allowing each carrier channel to transmit simultaneously in the fiber. In the embodiment, the present disclosure utilizes a dense wavelength division multi task technology to enable the optical module device to use four channels to receive or transmit four different channel wavelengths (λ1, λ2, λ3, λ4), so an optical signal L1 transmitted by the optical transmission interface 11A can have four wavelengths: λ1, λ2, λ3, λ4, etc., an optical signal L2 received by the optical receiving interface 11B can have four wavelengths: λ1, λ2, λ3, λ4, etc., and the fiber array structure 20 includes four fiber structures. The number of optical detection components of the optical detector 14B and laser components of the laser module 14A also correspond to the number of channels. Although the embodiment takes four channel configurations as an example, other channel configurations (for example, 2, 8, 16, 32, etc.) are also within the scope of the present disclosure.

As shown in FIG. 1, electrical data signals (TX_D1 to TX_D4) received by the transmission processing circuit 16A are output to the laser module 14A after a conversion processing, and the laser module 14A modulates the received electrical data signals into optical signals. The laser module 14A can include a single or multiple vertical cavity surface emitting laser diodes (VCSEL), or surface emitting laser diodes. Multiple vertical cavity surface emitting laser diodes form an array and are driven by a driving chip to emit optical signals. In other embodiments, other elements that can be used as light sources can also be used, such as light emitting diodes (LED), edge emitting laser diodes (EELD), distributed feedback laser (DFB) lasers with diffraction gratings, or electro-absorption modulated laser (EML) laser diode packages. The optical multiplexer 12A converts the modulated optical signals corresponding to the electrical data signals (TX_D1 to TX_D4) to an optical signal L1 including the wavelengths of λ1, λ2, λ3, λ4, etc., which is transmitted to optical emitting interface 11A for output to the optical fiber array 20.

The optical signal L2 is transmitted to the optical demultiplexer 12B via the optical receiving interface 11B. In the embodiment, the optical signal L2 is divided into optical signals corresponding to wavelengths of λ1, λ2, λ3, λ4, etc. by the optical demultiplexer 12B using the arrayed waveguide grating (AWG) technology. The optical detector 14B (in the embodiment, four as an example, but not limited to) detects optical signals and generates corresponding electrical signals. In the embodiment, the optical detector 14B can include a PIN (P-doped-intrinsic-doped-N) diode or an avalanche photodiode (APD). After the electrical signal generated by the optical detector 14B is processed by an amplification circuit (such as a trans impedance amplifier (TIA)) and a conversion circuit of the receiving processing circuit 16B, the electrical data signals transmitted by the optical signal L2 (such as RX_D1 to RX_D4) can be obtained. In other embodiments of the present disclosure, the optical demultiplexer 12B can also convert optical signal L2 into optical signals of different wavelengths by using fiber bragg grating (FBG) and other related technologies.

In the embodiment, the transmitter optical subassembly 10A and the receiver optical subassembly 10B can also include other functional circuit elements, such as a laser driver used to drive the laser module 14A, an automatic power control (APC), a monitor photo diode (MPD) used to monitor a laser power, and other circuit elements necessary for implementing the optical signal transmission function, receiving optical signals and processing, as well as digital signal processing integrated circuits used to process the electrical signals transmitted from the receiver optical subassembly 10B and the electrical signals to be transmitted to the transmitter optical subassembly 10A, which are well known to those skilled in the art, and will not be repeated here for simplified description.

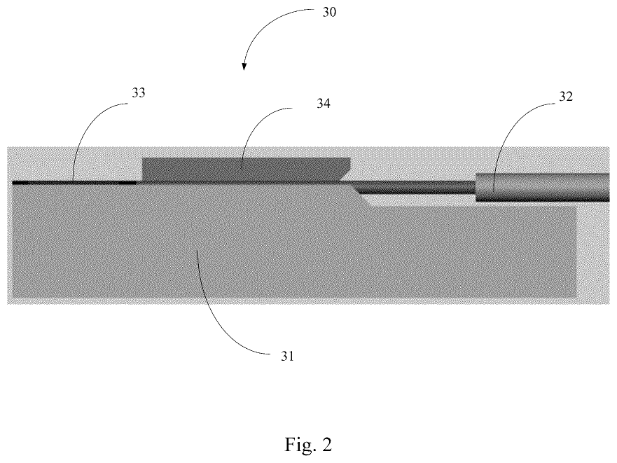

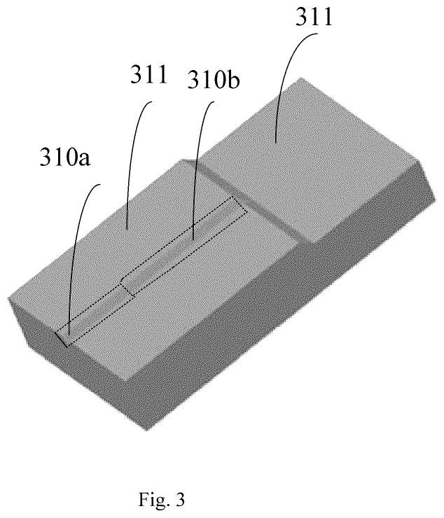

FIG. 2 is an outside view of an optical fiber structure 30 according to an embodiment of the present disclosure. As shown in FIG. 2, the optical fiber structure 30 includes a substrate 31, an optical fiber cable 32, and an isolator 33. A plurality of optical fiber structures 30 can constitute the optical fiber array structure 20. The substrate 31 is provided with a holding slot 310 to accommodate the optical fiber cable 32. In combination with FIG. 3, FIG. 3 is an outside view of the substrate 31 according to an embodiment of the present disclosure. The substrate 31 includes a first part 311 and a second part 312, and the first part 311 is higher than the second part 312. Holding slots 310a and 310b are arranged on the first part 311, which can be U-shaped slots or V-shaped slots. In the embodiment, the substrate 31 can be made of different materials, such as plastic materials, epoxy materials, composite materials, FR-4 materials or ceramic materials.

The optical cable 32 is partially accommodated in the holding slot 310, and can be fixed in the holding slot 310 through an adhesive layer. The adhesive layer can include polyimide (PI), polyethylene terephthalate (PET), teflon, liquid crystal polymer (LCP), polyethylene (PE), polypropylene (PP), polystyrene (PS), polyvinyl chloride (PVC), nylon or polyamides, polymethyl methacrylate (PMMA), acrylonitrile-butadiene-styrene, phenolic resin, epoxy, polyester, silicone, polyurethane (PU), polyamide imide (PAI) or a combination thereof, but not limited to this, as long as the materials with adhesion characteristics can be applied to the present disclosure. An outer coating layer of the optical fiber cable 32 accommodated at the holding slot 310 can be removed to reduce the size of the holding slot 310.

In the embodiment, the optical fiber structure 30 can also comprises a protective plate 34 on the substrate 31 and the protective plate 34 covers a part of the optical fiber cable 32 to protect the optical fiber cable 32.

The isolator 33 includes a positioning structure 330 arranged in the holding slot 310 and aligned with an end surface of the optical fiber cable 32. The isolator 33 is a dual port optical device with nonreciprocal characteristics. The isolator 33 has a small attenuation of the optical signal transmitted in a forward direction and a large attenuation of the optical signal transmitted in an opposite direction, forming a one-way path of light. Inserting an optical isolator between the optical emitting device and the transmission fiber can effectively suppress the reflected light generated from a far end surface of the optical fiber, an interface of the fiber connector, etc. in an optical transmission line from returning to the optical emitting device, thereby ensuring the stability of the working state of the optical emitting device, to reduce the noise caused by reflected light in the system, which is more important for high-speed optical fiber communication related optical fiber communication systems. The end surface treatment of optical fiber is an end surface preparation, which is a key process in optical fiber technology. The quality of the end surface directly affects the optical coupling efficiency and optical output power of the optical fiber. The end surface treatment of optical fiber mainly includes three steps: stripping, cleaning and cutting. In order to make the end surface of the optical fiber cable 32 meet the requirements of optical transmission and improve the optical coupling efficiency and optical output power, in the embodiment, the end surface of the optical fiber cable 32 is processed by femtosecond laser cutting technology.

The isolator 33 is accommodated in the holding slot 310 by an adhesive layer. The adhesive layer can include polyimide (PI), polyethylene terephthalate (PET), teflon, liquid crystal polymer (LCP), polyethylene (PE), polypropylene (PP), polystyrene (PS), polyvinyl chloride (PVC), nylon or polyamides, polymethyl methacrylate (PMMA), acrylonitrile-butadiene-styrene, phenolic resin, epoxy, polyester, silicone, polyurethane (PU), polyamide imide (PAI) or a combination thereof, but not limited to this, as long as the materials with adhesion characteristics can be applied to the present disclosure.

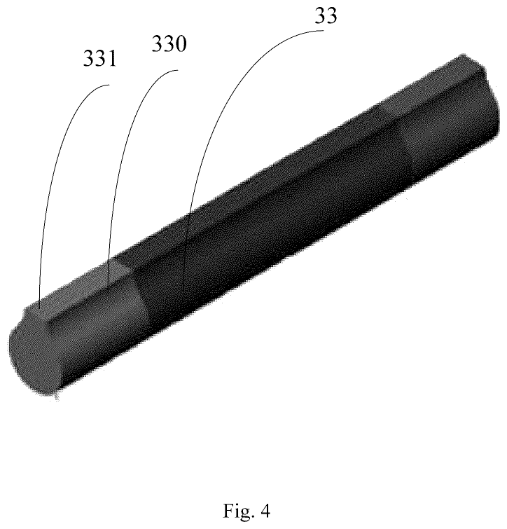

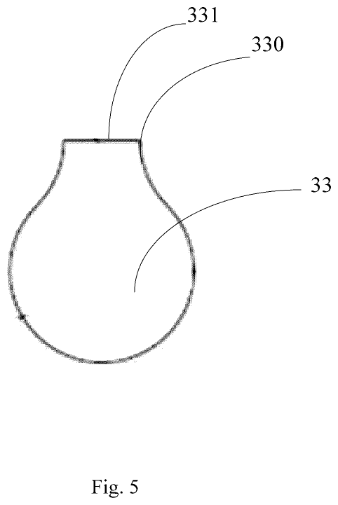

In combination with FIG. 4 and FIG. 5, FIG. 4 is an outside view of the isolator 33 according to an embodiment of the present disclosure; FIG. 5 is a side view of the isolator 33 according to an embodiment of the present disclosure. As shown in the figure, the isolator 33 includes a positioning structure 330, which is a circle with a positioning plane 331.

In the embodiment, the holding slot 310 includes a first sub-holding slot 310a and a second sub-holding slot 310b. The first sub-holding slot 310a is configured to accommodate the isolator 33. The slot size of the first sub-holding slot 310a is set according to the diameter of the isolator 33. The second sub-holding slot 310b is configured to accommodate the optical fiber cable 32. The slot size of the second sub-holding slot 310b is set according to the diameter of the optical fiber cable 32.

In the embodiment, a plurality of optical fiber structures 30 can form an optical fiber array structure 20, and there is a preset spacing between adjacent optical fiber structures. The preset spacing is determined according to actual needs. The number of optical fiber structures 30 is determined according to the actual demand and is not limited here.

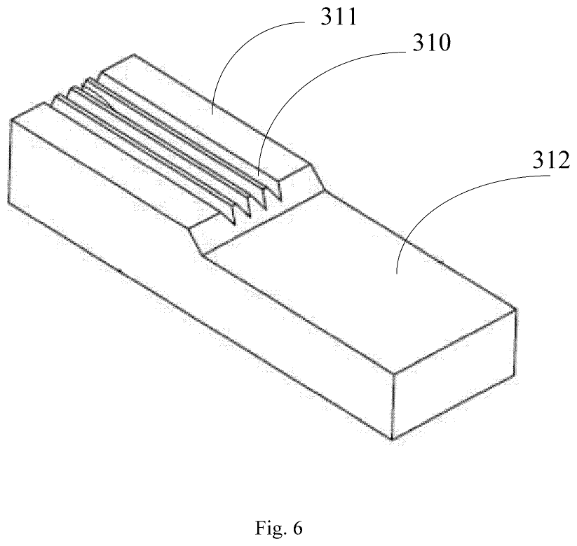

In other embodiments of the present disclosure, the optical fiber structure 30 is arranged on the same substrate to form an optical fiber array structure 20. Specifically, a plurality of holding slots 310 are disposed on the substrate, as shown in FIG. 6. FIG. 6 is an outside view of the substrate 31 according to another embodiment of the present disclosure. As shown in the figure, a plurality of holding slots 310 are arranged on the same substrate, and there is a preset spacing between the adjacent holding slots. In the embodiment, the optical fiber array structure further includes a plurality of optical fiber cables and a plurality of isolators. The plurality of optical fiber cables are respectively accommodated in the plurality of holding slots to form an optical fiber array. Each isolator includes a positioning structure, and each isolator is a circle with a positioning plane. The plurality of isolators are respectively arranged in the holding slots, and are respectively aligned and attached to the end surface of the corresponding optical fiber cable. An end surface of each optical fiber cable is processed by a femtosecond laser cutting technology.

In the embodiment, the optical fiber array structure further includes a protective plate, arranged on the substrate and covering part of the plurality of optical fiber cable. A coating layer of the part of each optical fiber cable arranged in the holding slot is removed.

In the embodiment, each holding slot includes: a first sub-holding slot, configured to accommodate a corresponding isolator, and a slot hole size of the first sub-holding slot is set according to a diameter of the a corresponding isolator; a second holding slot, configured to accommodate a corresponding optical fiber cable, and a slot size of the second sub-holding slot is set according to a diameter of the a corresponding optical fiber cable.

According to the optical fiber structure described in the embodiment of the present disclosure, the isolator is accommodated in the holding slot, and the holding slot is directly aligned with the end surface of the optical fiber cable, which can not only improve the optical coupling accuracy, but also make the optical fiber structure more compact, providing a basis for the product to be miniaturized and integrated. Furthermore, the isolator includes a positioning structure, and the isolator has a unidirectional transmission characteristic, therefore, the positioning structure greatly reduces the assembly difficulty and improves the assembly efficiency.

Many details are often found in the relevant art and many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An optical fiber structure, comprising:
a substrate, provided with a holding slot;
an optical fiber cable, partially accommodated in the holding slot; and
an isolator, comprising a positioning structure, wherein the isolator is accommodated in the holding slot and aligned with an end surface of the optical fiber cable.

2. The optical fiber structure according to claim 1, further comprising a protective plate, arranged on the substrate and covering part of the optical fiber cable.

3. The optical fiber structure according to claim 1, wherein a coating layer of the part of the optical fiber cable arranged in the holding slot is removed.

4. The optical fiber structure according to claim 1, the isolator is a circle with a positioning plane.

5. The optical fiber structure according to claim 1, wherein the holding slot comprises:
a first sub-holding slot, configured to accommodate the isolator, and a slot hole size of the first sub-holding slot is set according to a diameter of the isolator;
a second sub-holding slot, configured to accommodate the optical fiber cable, and a slot size of the second sub-holding slot is set according to a diameter of the optical fiber cable.

6. The optical fiber structure according to claim 1, wherein an end surface of the optical fiber cable is processed by a femtosecond laser cutting technology.

7. An optical fiber array structure, comprising a plurality of optical fiber structures, wherein each optical fiber structure comprises:
a substrate, provided with a holding slot;
an optical fiber cable, partially accommodated in the holding slot; and
an isolator, comprising a positioning structure, wherein the isolator is accommodated in the holding slot and aligned with an end surface of the optical fiber cable.

8. The optical fiber array structure according to claim 7, further comprising a protective plate, arranged on the substrate and covering part of the optical fiber cable.

9. The optical fiber array structure according to claim 7, wherein a coating layer of the part of the optical fiber cable arranged in the holding slot is removed.

10. The optical fiber array structure according to claim 7, the isolator is a circle with a positioning plane.

11. The optical fiber array structure according to claim 7, wherein the holding slot comprises:
a first sub-holding slot, configured to accommodate the isolator, and a slot hole size of the first sub-holding slot is set according to a diameter of the isolator;
a second sub-holding slot, configured to accommodate the optical fiber cable, and a slot size of the second sub-holding slot is set according to a diameter of the optical fiber cable.

12. The optical fiber array structure according to claim 7, wherein an end surface of the optical fiber cable is processed by a femtosecond laser cutting technology.

13. The optical fiber array structure according to claim 7, wherein there is a preset spacing between adjacent optical fiber structures.

14. An optical fiber array structure, comprising:
a substrate, provided with a plurality of holding slots;
a plurality of optical fiber cables, respectively arranged in the plurality of holding slots; and
a plurality of isolators, wherein each isolator comprises a positioning structure, and the plurality of isolators are respectively arranged in the holding slots, and respectively aligned with an end surface of a corresponding optical fiber cable.

15. The optical fiber array structure according to claim 14, wherein there is a preset spacing between the adjacent holding slots.

16. The optical fiber array structure according to claim 14, further comprising a protective plate, arranged on the substrate and covering part of the plurality of optical fiber cable.

17. The optical fiber array structure according to claim 14, wherein a coating layer of the part of each optical fiber cable arranged in the holding slot is removed.

18. The optical fiber array structure according to claim 14, wherein each isolator is a circle with a positioning plane.

19. The optical fiber array structure according to claim 14, wherein each holding slot comprises:
a first sub-holding slot, configured to accommodate a corresponding isolator, and a slot hole size of the first sub-holding slot is set according to a diameter of the a corresponding isolator;
a second holding slot, configured to accommodate a corresponding optical fiber cable, and a slot size of the second sub-holding slot is set according to a diameter of the a corresponding optical fiber cable.

20. The optical fiber array structure according to claim 14, wherein an end surface of each optical fiber cable is processed by a femtosecond laser cutting technology.
